(19) United States
(12) Patent Application Publication
(10) Pub. No.: US 2008/0174572 A1
(43) Pub. Date: Jul. 24, 2008

(54) Input apparatus

(75) Inventors: Eiji Katsuta, Aichi (JP); Fumitaka Hayase, Aichi (JP)

Correspondence Address: MORGAN LEWIS & BOCKIUS LLP, 1111 PENNSYLVANIA AVENUE NW, WASHINGTON, DC, 20004, US

(73) Assignee: Kabushiki Kaisha Tokai Rika Denki Seisakusho

(21) Appl. No.: 12/007,356

(22) Filed: Jan. 9, 2008

(30) Foreign Application Priority Data
Jan. 19, 2007 (JP) P2007-010367
Jan. 19, 2007 (JP) P2007-010368

(51) Int. Cl. G06F 3/033

(52) U.S. Cl. 345/184

(57) ABSTRACT

An input apparatus is provided which comprises a thumbwheel integrated with a rotational shaft which rotates and oscillates, an encoder (a rotation detector) for detecting a rotational amount of the rotational shaft, and a switch operated by oscillation of the rotational shaft, wherein a first gearwheel (a rotational element) is provided between the rotational shaft and the encoder, and wherein the rotational shaft is connected to the first gearwheel in such a manner as not only to oscillate but also to transmit the rotation of the rotational shaft to the first gearwheel. Operation load applied when the thumbwheel is operated to be pushed to thereby operate the switch is applied not to the encoder but to the first gearwheel to which the rotational shaft is connected.

### BACKGROUND OF THE INVENTION

The present invention relates to an input apparatus which includes an operating portion which is configured to be operated in such a manner as not only to rotate but also to be pushed and a rotation detector for detecting a rotational amount of the operating portion.

An operating portion which is configured to be operated in such a manner as to rotate but also to be pushed is provided in, for example, an input apparatus for operating a motor vehicle's in-car navigation system, and an operating portion of this type is generally referred to as a thumbwheel because the operating portion is operated by the thumb in many cases. This thumbwheel is integrated with a rotational shaft which rotates and oscillates, and one end side of the rotational shaft is connected to an encoder (the rotation detector) for detecting a rotational amount of the thumbwheel and the other end side of the rotational shaft is disposed in a position which faces an input determination switch. Then, when the thumbwheel rotates, items displayed on a display screen are made to sequentially be selected according to rotational amounts of the rotational shaft which are detected by the encoder. In addition, when the thumbwheel is operated to be pushed, the switch is operated by oscillation of the rotational shaft, so as to input the item so selected (for example, refer to JP-2001-A-350573).

According to the input apparatus that is configured as has been above, the input operation can be implemented with ease by operating the thumbwheel in such a manner as to rotate and push it. However, since the rotational shaft of the thumbwheel is supported by the encoder at the one end side thereof, operation load applied when operating the thumbwheel in such a manner as to push it is directly applied to the encoder. Due to this, there is a fear that a failure of the encoder is called for, this resulting in a problem that the durability and reliability of the input apparatus are decreased.

Further, in the input apparatus of this type, an operation feeling is made to be obtained or felt by the user when he or she operates to rotate the thumbwheel, for example, so that the user can identify a rotational amount of the thumbwheel with sensation. In the input apparatus which is configured as has been described above, however, the operation feeling felt by the user when he or she operates to rotate the thumbwheel is given by the encoder which supports the one end of the rotational shaft of the thumbwheel. Due to this, the operation feeling felt by the user when operating to rotate the thumbwheel cannot be set arbitrarily, and hence, an operation feeling which can meet the user's needs cannot be realized.

### SUMMARY OF THE INVENTION

The invention has been made in view of these situations, and an object thereof is to provide an input apparatus which can prevent the failure of the rotation detector due to the operation load applied thereto when the operating portion is operated to be pushed and which can improve the durability and reliability thereof.

A further object of the invention is to provide an input apparatus which can arbitrarily set the operation feeling felt when the operating portion is operated to rotate, so as to realize an operation feeling which meets the user's needs.

According to an aspect of the invention, there is provided an input apparatus including an operating portion integrated with a rotational shaft which rotates and oscillates, a rotation detector for detecting a rotational amount of the rotational shaft, and a switch operated by oscillation of the rotational shaft, wherein a rotational element is provided between the rotational shaft and the rotation detector, and wherein the rotational shaft is connected to the rotational element in such a manner as not only to oscillate but also to transmit the rotation of the rotational shaft to the rotational element.

According to the input apparatus of the invention, when the operating portion is operated to rotate, the rotation of the rotational shaft is transmitted to the rotational element, and the rotation detector detects a rotational amount of the rotational element as a rotational amount of the operating portion. On the other hand, when the operating portion is operated to be pushed, the rotational shaft oscillates at an engagement portion with the rotational element as a fulcrum to thereby operate the switch. In this case, operation load applied when the operating portion is operated to be pushed is applied to the rotational element to which the rotational shaft is connected, and hence, the operation load so applied is applied, in no case, directly to the rotation detector, whereby the failure of the rotation detector can be prevented which would otherwise be caused by the operation load applied thereto when the operating portion is operated to be pushed, thereby making it possible to increase the durability and reliability of the input apparatus.

According to an aspect of the invention, there is provided an input apparatus including an operating portion integrated with a rotational shaft which rotates and oscillates, a rotation detector for detecting a rotational amount of the rotational shaft, and a switch operated by oscillation of the rotational shaft, the input apparatus including a click receiving portion which is provided on a circumferential side portion of the rotational shaft by forming the circumferential side portion into a non-circular shape in cross section, and a contact portion which is brought into elastic contact with the click receiving portion.

According to the input apparatus of the invention, when the operating portion is operated to rotate, the elastically contact portion of the contact portion relative to the click receiving portion of the non-circular cross section changes as the rotational shaft rotates, and as this occurs, a click feeling (an operation feeling) is given to the rotation of the operating portion. In this configuration, by adjusting the strength with which the contact portion is brought into elastic contact with the click receiving portion, the operation feeling felt when the operating portion is operated to rotate can be set arbitrarily, thereby making it possible to realize an operation feeling which can meets the user's needs.

### BRIEF DESCRIPTION OF THE DRAWINGS

FIG. 1 is a vertically sectioned side view showing an embodiment of the invention, which shows schematically an interior configuration of an input apparatus.

FIG. 2 is a vertically sectioned side view of the input apparatus which shows a state in which a thumbwheel is operated to be pushed.

FIG. 3 is a front view of the input apparatus.

FIG. 4 is a diagram showing an engagement portion and an engaged portion.

FIG. 5 is a vertically sectioned side view showing an embodiment of the invention, which schematically shows an interior configuration of an input apparatus.

FIG. 6 is a vertically sectioned side view of the input apparatus which shows a state in which a thumbwheel is operated to be pushed.

FIG. 7 is a front view of the input apparatus.

FIG. 8 is a diagram showing a click receiving portion and a contact piece.

### DETAILED DESCRIPTION OF PREFERRED EMBODIMENTS

### First Embodiment

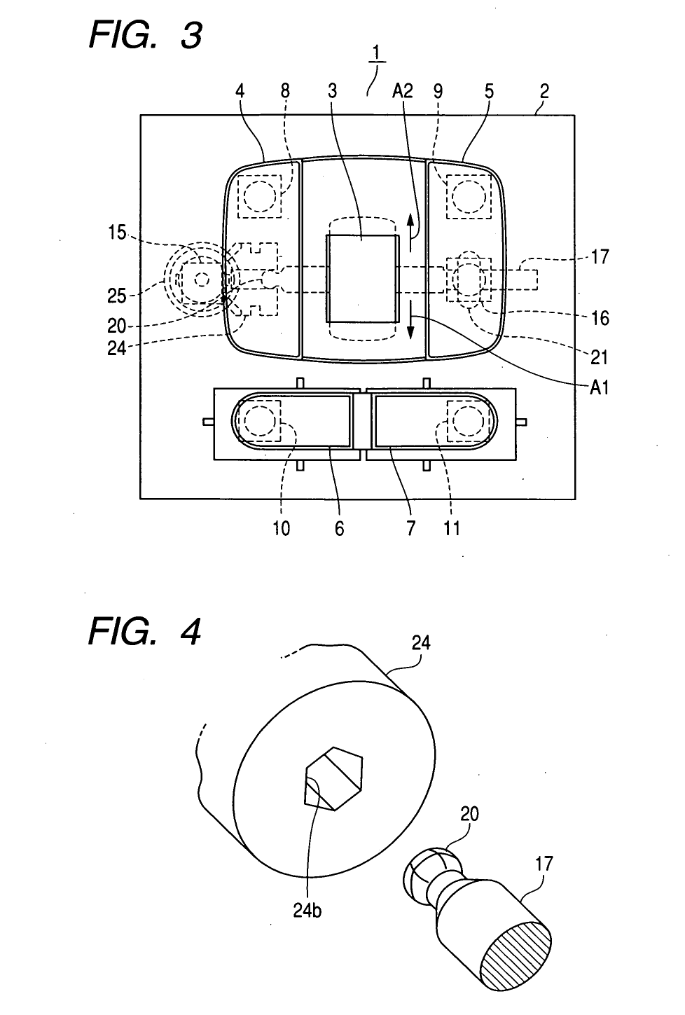

Hereinafter, a first embodiment of the invention will be described by reference to the drawings in which the invention is applied, for example, to an input apparatus 1 for controlling a motor vehicle's in-car navigation system. In the first embodiment, the input apparatus 1 shown in FIG. 3 is provided, for example, on an intermediate portion (a spoke) which connects together a central portion (a hub) and an outer circumferential portion (a rim) of a steering wheel, none of which is shown in the figure.

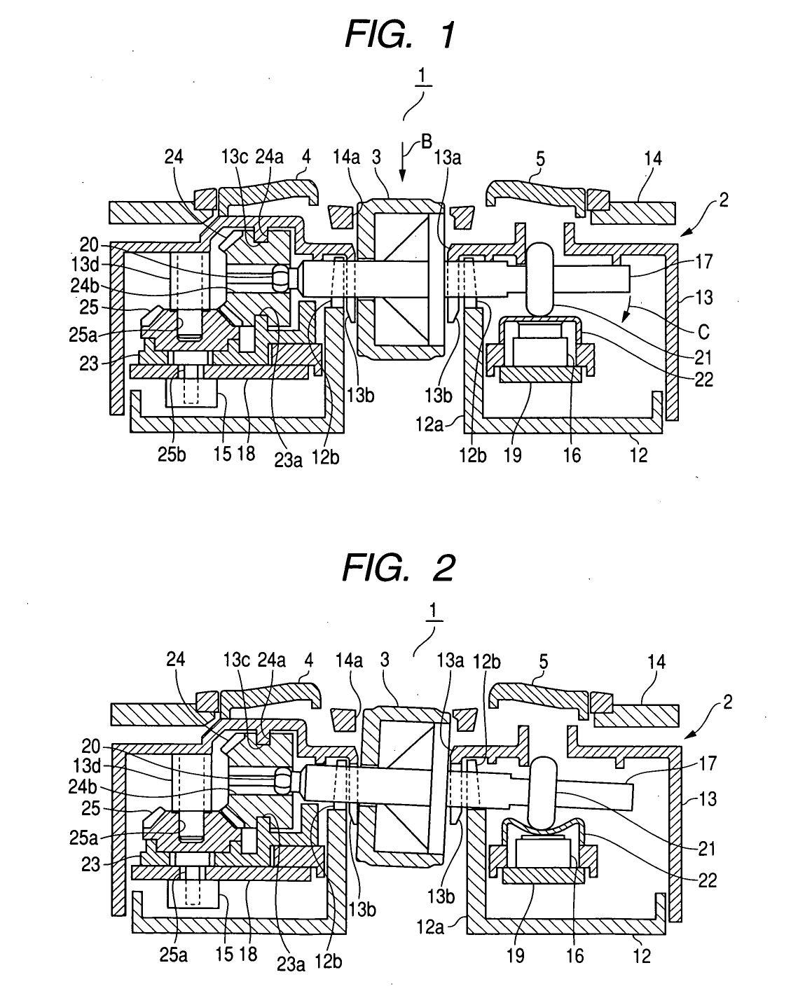

Provided on a case main body 2 which makes up an outer shell of the input apparatus 1 are a thumbwheel 3 (which corresponds to the operating portion) which is provided substantially in a central portion of the case main body 2, a pair of large buttons 4, 5 provided on left and right sides of the thumbwheel 3, respectively, and a pair of left and right small buttons 6, 7 provided below the thumbwheel 3. The thumbwheel 3 is formed substantially into a circular disc-like shape whose axis extends horizontally, and is made not only to be operated to rotate about a rotational shaft 17 in directions indicated by arrows A1, A2 in FIG. 3 and but also to be operated to be pushed in a direction indicated by an arrow B in FIG. 1 from a front surface side of the input apparatus 1 by virtue of a configuration which will be described later. The large buttons 4, 5 and small buttons 6, 7 are made to be operated to be pushed from the front surface side of the input apparatus 1, respectively, and when these buttons 4, 5, 6, 7 are so operated, switches 8, 9, 10, 11 provided within the case main body 2 are made to be operated, respectively.

Next, an internal configuration of the input apparatus 1 will be described by reference to FIG. 1. The case main body 2 is made up of a base member 12 which makes up a rear portion side (a lower side in FIG. 1) of the case main body 2, a lid member 13 which covers the base member 12, and a front cover 14 which covers a front side (an upper side in FIG. 1) of the lid member 13. A drainage hole 12a is provided in a central portion of the base member 12, and an opening 13a and an opening 14a are provided in central portions of the lid member 13 and the front cover 14, respectively.

In addition to the thumbwheel 3, an encoder 15 (which corresponds to the rotation detector) and a switch 16 are provided in the case main body 2. The encoder 15 is such as to detect a rotational amount of the rotational shaft 17 and is disposed on a control substrate 18 which is provided in one side (a left-hand side in FIG. 1) portion within the case main body 2. The switch 16 is such as to determine an input operation to the in-car navigation system and is disposed in the other side (a right-hand side in FIG. 1) portion within the case main body 2.

The thumbwheel 3 is integrated with the rotational shaft 17 and is disposed within a space which is defined by the drainage hole 12a, the opening 13a and the opening 14a. In addition, part of a circumferential side portion of the thumbwheel 3 is made to project from a front surface of the case main body 2. An engagement portion 20 is provided at one end (the left-hand side in FIG. 1) of the rotational shaft 17, and this engagement portion 20 is formed into a substantially spherical shape as viewed in a radial direction and into a polygonal shape (for example, a hexagonal shape) as viewed in an axial direction.

In addition, a diametrically enlarged portion 21, which is larger in diameter than the rotational shaft 17, is provided on the other end (the right-hand side in FIG. 1) of the rotational shaft 17, and this diametrically enlarged portion 21 is placed and supported on an elastically deformable switch cover 22 which is adapted to cover the switch 16. In addition, portions of the rotational shaft 17 which lie near both left and right sides of the thumbwheel 3 are surrounded by a wall 12b which projects forwards (upwards in FIG. 1) into a U-shape from the drainage hole 12b and a wall 13b which project rearwards (downwards in FIG. 1) into a U-shape from the opening 13a, whereby intrusion of water towards the encoder 15 side and the switch 16 side within the case main body 2 is made to be prevented as much as possible by the walls so formed.

A gearwheel support member 23 is provided on the control substrate 18, and a first gearwheel 24 (which corresponds to the rotational element) whose axis is made to be oriented horizontally and a second gearwheel 25 whose axis is made to be oriented vertically are disposed on the gearwheel support member 23 are disposed on the gearwheel support member 23. A groove portion 24a is formed on a circumferential side portion of the first gearwheel 24 in such a manner as to extend along a circumferential direction of the first gearwheel 24 and a support portion 23a provided on the gearwheel support member 23 and a support portion 13c provided on an inner surface of the lid member 13 are fitted in the groove portion 24a, whereby the first gearwheel 24 is supported in such a manner as to rotate round the horizontal axis thereof.

A bearing hole 25a is formed in a central portion on a front side (an upper side in FIG. 1) of the second gearwheel 25, and a shaft portion 13d, which projects rearwards from the inner surface of the lid member 13, is inserted into the bearing hole 25a, whereby the second gearwheel 25 is supported in such a manner as to rotate round the vertical axis thereof. A rotational shaft 25b is provided in a central portion on a rear side (a lower side in FIG. 1) of the second gearwheel 25 in such a manner as to extend rearwards, and this rotational shaft 25b is connected to the encoder 15.

In this case, the first gearwheel 24 and the second gearwheel 25 are made up, respectively, of bevel gearwheels, which are assembled together in such a manner that axes thereof intersect each other at right angles and the second gearwheel 25 is made to rotate in response to rotation of the first gearwheel 24.

As is shown in FIG. 4, a hole having a hexagonal cross section as viewed in an axial direction thereof is formed in a central portion of the first gearwheel 24 as an engaged portion 24b in such a manner as to correspond to the shape of a circumferential side portion of the engagement portion 20 (which is a hexagonal shape), and the engagement portion 20 of the rotational shaft 17 is inserted into the engaged portion 24b, whereby not only is the first gearwheel 24 made to be rotated by the rotational shaft 17 when the thumbwheel 3 is operated to rotate, but also the rotational shaft 17 is made to oscillate in a direction indicated by an arrow C in FIG. 1 at the one end (the engagement portion 20) of the rotational shaft as a fulcrum when the thumbwheel 3 is operated to be pushed.

Next, the function of the configuration that has been described heretofore will be described by reference to FIGS. 1 and 2.

When the thumbwheel 3 is operated to rotate by the user in the direction indicated by the arrow A1 or the direction indicated by the arrow A2 in FIG. 3, the first gearwheel 24 is rotated by the rotational shaft 17, and the second gearwheel 25 rotates in response to rotation of the first gearwheel 24. A rotational amount of the second gearwheel 25 is detected by the encoder 15, and items displayed on a display screen (not shown) of the in-car navigation system are sequentially selected according to rotational amounts so detected by the encoder 15.

When the thumbwheel 3 is operated to be pushed in the direction indicated by the arrow B in FIG. 1 by the user in such a state that a desired item is selected, the rotational shaft 17 oscillates in the direction indicated by the arrow C in FIG. 1 at the engagement portion 20 as the fulcrum, whereby as is shown in FIG. 2, the switch 16 is operated by the diametrically enlarged portion 21, so that an input of the selected item is implemented.

Thus, according to the first embodiment that has been described heretofore, when the thumbwheel 3 is operated to rotate, the rotation of the rotational shaft 17 is transmitted to the first gearwheel 24, and the encoder 15 detects a rotational amount of the second gearwheel 25 which is rotated by the first gearwheel 24 as a rotational amount of the thumbwheel 3. On the other hand, when the thumbwheel 3 is operated to be pushed, the rotational shaft 17 oscillates at the engagement portion 20 as the fulcrum to thereby operate the switch 16. As this occurs, operation load applied when the thumbwheel 3 is operated to be pushed is applied to the first gearwheel 24 to which the rotational shaft 17 is connected but is not applied directly to the encoder 15 in any case, whereby the encoder 15 can be prevented from failing due to the operation load applied when the thumbwheel 3 is operated to be pushed, thereby making it possible to increase the durability and reliability of the input apparatus 1.

In addition, since the first gearwheel 24 and the second gearwheel 25 are proved between the rotational shaft 17 and the encoder 15, the first gearwheel 24 to which the operation load is applied is configured to be interposed between the encoder 15 and the second gearwheel 25, whereby the direct application of the operation load applied when the thumbwheel 3 is operated to be pushed to the encoder can be prevented further.

Note that the invention is not limited to the embodiment that has been described heretofore, and hence, the invention can be modified or improved in the following fashions.

The shape of the engagement portion 20 is not limited to the hexagonal shape which results as viewed in the axial direction but may be formed into a pentagonal shape which is smaller by one in the number of angles between straight sides than the hexagonal shape, or a heptagonal shape or an octagonal shape which is larger in the number of angles between straight sides than the hexagonal shape. As this occurs, the engaged portion 24b may only have to be provided in such a manner as to correspond to the shape of the circumferential side portion of the engagement portion formed.

A configuration may be adopted in which the axes of the first gearwheel 24 and the second gearwheel 25 intersect each other obliquely.

### Second Embodiment

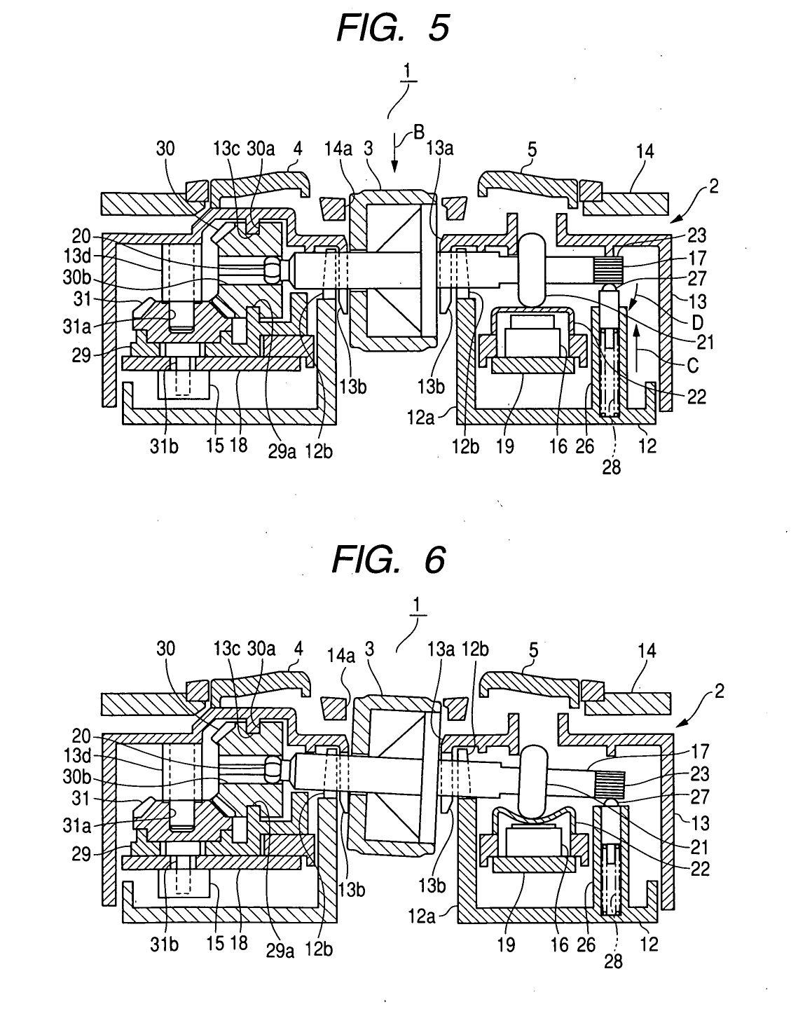

A second embodiment according to the present invention will be described with reference to FIGS. 5 to 8. In FIGS. 5 to 8, members the same as those of the first embodiment are attached with the same notations and detailed explanation thereof will be omitted.

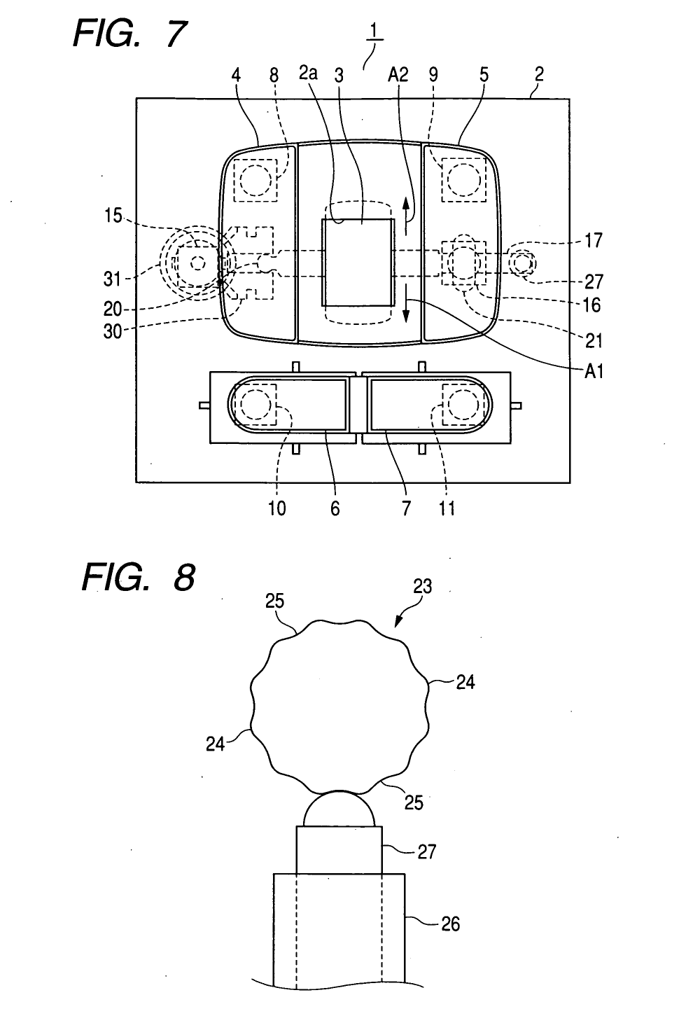

A click receiving portion 23, which is formed into a non-circular shape in cross section when the rotational shaft 17 is viewed in an axial direction thereof, is provided on a circumferential side portion at the other end of the rotational shaft 17. In the second embodiment, this click receiving portion 23 is, as is shown in FIG. 8, formed into a shape in which a plurality of (in this case, 12) peak portions 24 and a plurality of (in this case, 12) valley portions 25 are arranged alternately along a circumferential direction of the rotational shaft 17.

An accommodating portion 26 is provided on the base member 12 in such a manner as to project forwards (upwards in FIG. 5) from an inner surface of the base member 12, and a contact piece 27 (which corresponds to the contact portion) is accommodated in this accommodating portion 26. This contact piece 27 is in such a state as to be biased in a direction indicated by an arrow C in FIG. 5 towards the click receiving portion 23 on the rotational shaft 17 by a compression coil spring 28, whereby the contact piece 27 is brought into elastic contact with the click receiving portion 23.

Portions of the rotational shaft 17 which lie close to left and right sides of the thumbwheel 3 are surrounded by a wall 12b which projects forwards from the drainage hole 12a into a U-shape and a wall 13b which projects rearwards (downwards in FIG. 5) from the opening 13a into a U-shape, whereby intrusion of water to the encoder 15 side and the switch 16 side in the case main body 2 is made to be prevented as much as possible by the walls so provided.

Next, the function of the configuration that has been described heretofore will be described by reference to FIGS. 5 and 6.

When the user operates to rotate the thumbwheel 3 in the direction indicated by the arrow A1 or the arrow A2 in FIG. 7, the first gearwheel 30 is rotated by the rotational shaft 17, and the second gearwheel 31 rotates in response to the rotation of the first gearwheel 30. As this occurs, the contact piece 27 is brought into elastic contact with the peak portions 24 and the valley portions 25 of the click receiving portion 23 alternately as the rotational shaft 17 rotates. Namely, the elastic contact position of the contact piece 27 relative to the click receiving portion 23 of the non-circular cross section changes as the rotational shaft 17 rotates. A rotational amount of the second gearwheel 31 is detected by the encoder 15, and items displayed on a display screen (not shown) of the in-car navigation system are sequentially selected according to rotational amounts so detected.

When the user pushes the thumbwheel 3 in the direction indicated by the arrow B in FIG. 5 in such a state that a desired item is selected, the rotational shaft 17 oscillates in the direction indicated by the arrow D in FIG. 5 at the engagement portion 20 as the fulcrum, whereby the switch 16 is operated by the diametrically enlarged portion 21 as is shown in FIG. 6, whereby the input of the selected item is implemented.

Thus, as has been described heretofore, according to the second embodiment, when the thumbwheel 3 is operated to rotate, the elastic contact position of the contact portion 27 relative to the click receiving portion 23 of the non-circular cross section changes as the rotational shaft 17 rotates, whereby a click feeling (an operation feeling) is imparted to the rotation of the thumbwheel 3. In this configuration, by adjusting the strength with which the contact piece 27 is brought into elastic contact with the click receiving portion 23, the operation feeling that is to be felt when the thumbwheel 3 is operated to rotate can be set arbitrarily, thereby making it possible to realize an operation feeling which meets the user's needs.

In addition, the operation feeling that is to be felt when the thumbwheel 3 is operated to rotate can be realized without relying upon the encoder 15.

Note that the invention is not limited only to the second embodiment that has been described heretofore but can be modified and improved in the following fashions.

The numbers of the peak portions 24 and the valley portions 25 are not limited to 12, and hence, the peak portions 24 and the valley portions 23 may be provided more or less than 12. In addition, only one peak portion 24 or one valley portion 25 may be provided on the circumferential side portion of the rotational shaft 17.

The shape of the click receiving portion 23 is not limited to the shape in which the peak portions 24 and the valley portions 25 are arranged alternately, and hence, the click receiving portion 23 may be formed into a polygonal shape (for example, a hexagonal shape) in cross section as viewed in the axial direction of the rotational shaft 17.

The contact piece 27 is not limited to such as to be biased by the compression coil spring 28 but may be configured so as to be brought into elastic contact with the click receiving portion 23 directly by means of, for example, a leaf spring.

As to the connection between the rotational shaft 17 and the encoder 15, in place of the configuration in which the first gearwheel 30 and the second gearwheel 31 are provided between the rotational shaft 17 and the encoder 15, the rotational shaft 17 maybe connected directly to the encoder 15 at one end thereof.

The invention can be applied not only to the input apparatus for controlling the motor vehicle's in-car navigation system but also to an input apparatus, provide that the input apparatus is such as to include an operating portion which is configured to be operated not only to rotate bus also to be pushed and a rotation detecting device for detecting a rotational amount of the operating portion.

What is claimed is:

1. An input apparatus comprising:
an operating portion integrated with a rotational shaft which rotates and oscillates;
a rotation detector that detects a rotational amount of the rotational shaft;
a switch operated by oscillation of the rotational shaft; and
a rotational element provided between the rotational shaft and the rotation detector,
wherein the rotational shaft is connected to the rotational element so that the rotational shaft can oscillate and the rotation of the rotational shaft is transmitted to the rotational element.

2. The input apparatus according to claim 1, wherein an axis of a rotational shaft connected to the rotation detector intersects with an axis of the rotational element at a right angle.

3. An input apparatus comprising:
an operating portion integrated with a rotational shaft which rotates and oscillates;
a rotation detector that detects a rotational amount of the rotational shaft;
a switch operated by oscillation of the rotational shaft;
a click receiving portion which is provided on a circumferential side portion of the rotational shaft by forming the circumferential side portion into a non-circular shape in cross section; and
a contact portion which is brought into elastic contact with the click receiving portion.

4. The input apparatus according to claim 3 further comprising a rotational element provided between one end of the rotational shaft and the rotation detector,
wherein the click receiving portion is provided on the other end of the rotational shaft.
